(19) United States
(12) Patent Application Publication
(10) Pub. No.: US 2023/0299897 A1
(43) Pub. Date: Sep. 21, 2023

(54) CONFIGURING A SIDELINK HYBRID AUTOMATIC REPEAT REQUEST

(71) Applicant: Lenovo (Singapore) Pte. Ltd., New Tech Park (SG)

(72) Inventors: Karthikeyan Ganesan, Kronberg im Taunus (DE); Prateek Basu Mallick, Dreieich (DE); Joachim Loehr, Wiesbaden (DE); Ravi Kuchibhotla, Chicago, IL (US)

(21) Appl. No.: 18/019,453

(22) PCT Filed: Aug. 5, 2021
(86) PCT No.: PCT/IB2021/057207

§ 371 Date: Feb. 2, 2023

Related U.S. Application Data
(60) Provisional application No. 63/061,715, filed on Aug. 5, 2020.
(60) Provisional application No. 63/061,725, filed on Aug. 5, 2020.
(60) Provisional application No. 63/061,731, filed on Aug. 5, 2020.
(60) Provisional application No. 63/061,734, filed on Aug. 5, 2020.
(60) Provisional application No. 63/061,746, filed on Aug. 5, 2020.

(51) Int. Cl. H04L 1/1867; H04L 1/1812; H04W 72/40

(52) U.S. Cl. CPC H04L 1/1896; H04L 1/1812; H04W 72/40; H04W 88/04

(57) ABSTRACT

Apparatuses, methods, and systems are disclosed for configuring a sidelink hybrid automatic repeat request. One method includes communicating, via a first sidelink device, with a second sidelink device using a first sidelink communication interface. The second sidelink device communicates with a third sidelink device using a second sidelink communication interface. The method includes transmitting a sidelink hybrid automatic repeat request configuration to the second sidelink device via the first sidelink communication interface. The sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

### CROSS-REFERENCE TO RELATED APPLICATIONS

This application claims priority to U.S. Patent Application Ser. No. 63/061,715 entitled “APPARATUSES, METHODS, AND SYSTEMS FOR A SIDELINK RESOURCE ALLOCATION PROCEDURE FOR SIDELINK RELAY COMMUNICATION” and filed on Aug. 5, 2020 for Joachim Loehr, U.S. Patent Application Ser. No. 63/061,725 entitled “MECHANISMS FOR IMPROVED COMMUNICATIONS USING RELAY OVER SIDELINK RADIO INTERFACE” and filed on Aug. 5, 2020 for Prateek Basu Mallick, U.S. Patent Application Ser. No. 63/061,731 entitled “SELECTION OF RELAY DEVICE IN SIDELINK COMMUNICATIONS” and filed on Aug. 5, 2020 for Prateek Basu Mallick, U.S. Patent Application Ser. No. 63/061,734 entitled “MECHANISMS TO SUPPORT TRANSMISSION FEEDBACK OVER SIDELINK RELAY” and filed on Aug. 5, 2020 for Prateek Basu Mallick, and U.S. Patent Application Ser. No. 63/061,746 entitled “APPARATUSES, METHODS, AND SYSTEMS FOR DETERMINING THE BEHAVIOUR OF A SIDELINK RELAY UE USING MCR AND ZONE” and filed on Aug. 5, 2020 for Karthikeyan Ganesan, all of which are incorporated herein by reference in their entirety.

### FIELD

The subject matter disclosed herein relates generally to wireless communications and more particularly relates to configuring a sidelink hybrid automatic repeat request.

### BACKGROUND

In certain wireless communications networks, feedback may be transmitted via sidelink. A configuration of the feedback mechanism may be unknown.

### BRIEF SUMMARY

Methods for configuring a sidelink hybrid automatic repeat request are disclosed. Apparatuses and systems also perform the functions of the methods. One embodiment of a method includes communicating, via a first sidelink device, with a second sidelink device using a first sidelink communication interface. The second sidelink device communicates with a third sidelink device using a second sidelink communication interface. In some embodiments, the method includes transmitting a sidelink hybrid automatic repeat request configuration to the second sidelink device via the first sidelink communication interface. In certain embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

One apparatus for configuring a sidelink hybrid automatic repeat request includes a first sidelink device. In some embodiments, the apparatus includes a transceiver that:

communicates with a second sidelink device using a first sidelink communication interface, wherein the second sidelink device communicates with a third sidelink device using a second sidelink communication interface; and transmits a sidelink hybrid automatic repeat request configuration to the second sidelink device via the first sidelink communication interface. In certain embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

Another embodiment of a method for configuring a sidelink hybrid automatic repeat request includes communicating, via a second sidelink device, with a first sidelink device using a first sidelink communication interface, and communicating with a third sidelink device using a second sidelink communication interface. In some embodiments, the method includes receiving a sidelink hybrid automatic repeat request configuration from the first sidelink device via the first sidelink communication interface. In certain embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

Another apparatus for configuring a sidelink hybrid automatic repeat request includes a second sidelink device. In some embodiments, the apparatus includes a transceiver that: communicates with a first sidelink device using a first sidelink communication interface, and communicates with a third sidelink device using a second sidelink communication interface; and receives a sidelink hybrid automatic repeat request configuration from the first sidelink device via the first sidelink communication interface. In various embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

### BRIEF DESCRIPTION OF THE DRAWINGS

A more particular description of the embodiments briefly described above will be rendered by reference to specific embodiments that are illustrated in the appended drawings.

Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a sidelink hybrid automatic repeat request;

FIG. 2 is a schematic block diagram illustrating one embodiment of an apparatus that may be used for configuring a sidelink hybrid automatic repeat request;

FIG. 3 is a schematic block diagram illustrating one embodiment of an apparatus that may be used for configuring a sidelink hybrid automatic repeat request;

FIG. 4 is a schematic block diagram illustrating one embodiment of a system for relay communications;

FIG. 5 is a schematic block diagram illustrating one embodiment of a system in which MCR is perceived from a TX remote UE;

FIG. 6 is a schematic block diagram illustrating one embodiment of a system in which MCR is perceived from a relay UE;

FIG. 7 is a schematic block diagram illustrating one embodiment of a system including a selection window of a TX remote UE and a relay UE;

FIG. 8 is a flow chart diagram illustrating one embodiment of a method for configuring a sidelink hybrid automatic repeat request; and

FIG. 9 is a flow chart diagram illustrating another embodiment of a method for configuring a sidelink hybrid automatic repeat request.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read- only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

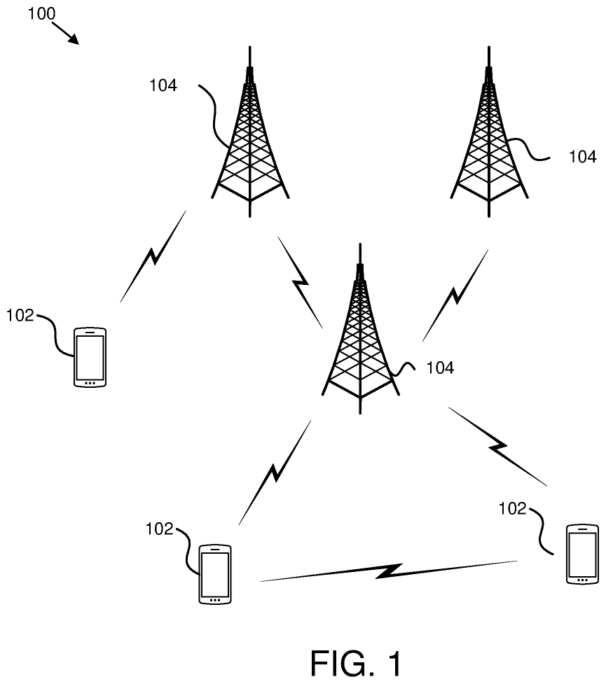

FIG. 1 depicts an embodiment of a wireless communication system 100 for configuring a sidelink hybrid automatic repeat request. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may communicate, via a first sidelink device, with a second sidelink device using a first sidelink communication interface. The second sidelink device communicates with a third sidelink device using a second sidelink communication interface. In some embodiments, the remote unit 102 may transmit a sidelink hybrid automatic repeat request configuration to the second sidelink device via the first sidelink communication interface. In certain embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof. Accordingly, the remote unit 102 may be used for configuring a sidelink hybrid automatic repeat request.

In certain embodiments, a remote unit 102 may communicate, via a second sidelink device, with a first sidelink device using a first sidelink communication interface, and communicate with a third sidelink device using a second sidelink communication interface. In some embodiments, the remote unit 102 may receive a sidelink hybrid automatic repeat request configuration from the first sidelink device via the first sidelink communication interface. In certain embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof. Accordingly, the remote unit 102 may be used for configuring a sidelink hybrid automatic repeat request.

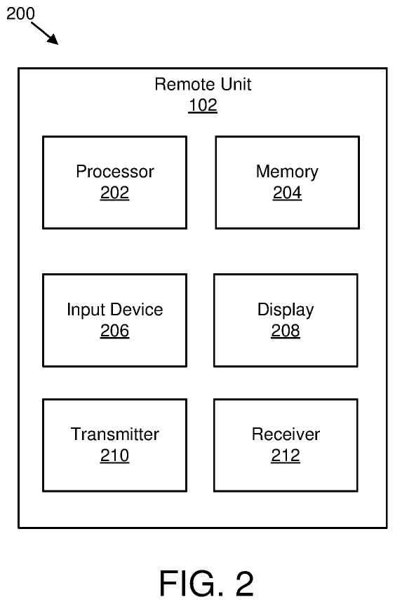

FIG. 2 depicts one embodiment of an apparatus 200 that may be used for configuring a sidelink hybrid automatic repeat request. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transceiver: communicates with a second sidelink device using a first sidelink communication interface, wherein the second sidelink device communicates with a third sidelink device using a second sidelink communication interface; and transmits a sidelink hybrid automatic repeat request configuration to the second sidelink device via the first sidelink communication interface. In certain embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In some embodiments, the transceiver: communicates with a first sidelink device using a first sidelink communication interface, and communicates with a third sidelink device using a second sidelink communication interface; and receives a sidelink hybrid automatic repeat request configuration from the first sidelink device via the first sidelink communication interface. In various embodiments, the sidelink hybrid automatic repeat request configuration includes a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

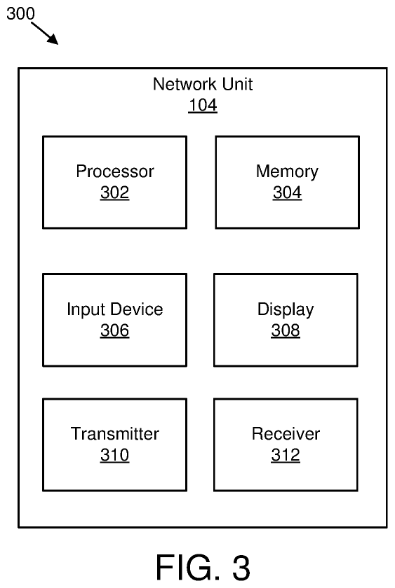

FIG. 3 depicts one embodiment of an apparatus 300 that may be used for configuring a sidelink hybrid automatic repeat request. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, there may be two types of relays: 1) UE-to-network coverage extension: UE to network (“Uu”) interface coverage reachability may be necessary for UEs to reach a server in a packet data network (“PDN”) or counterpart user equipment (“UE”) out of a proximity area—various embodiments for UE-to-network relays may be limited to evolved universal terrestrial access (“EUTRA”) based technologies, and may not be applied to an NR-based system (e.g., for both next generation (“NG”) radio access network (“RAN”) (“NG-RAN”) and NR-based sidelink communications); and 2) UE-to-UE coverage extension: current proximity reachability may be limited to a single-hop sidelink link either via EUTRA-based or NR-based sidelink technology—this may not be sufficient if there is no Uu coverage, considering a limited single-hop sidelink coverage.

In various embodiments, for both sidelink (“SL”) relay types, a SL remote UE may discover and select a relay for transmissions to another SL remote UE. In certain embodiments, a reliability requirement is 10\hat{ }-5 and may increase with public safety. In some embodiments, communication applications like industrial internet of things (“IIoT”) and other applications may use sidelink and may require higher reliability and extended coverage. A SL relay may be used to increase coverage using one or more hops. Various embodiments found herein may be used to achieve higher reliability and extended coverage.

In certain embodiments, selection of SL relay UE transmission of a transport block (“TB”) based on a minimum communication range (“MCR”) value may be made, and signaling and behavior of the SL relay UE may be made considering distance-based feedback using MCR and zone id corresponding to remote UEs.

As used herein, the term eNB and/or gNB may be used for a base station, but may be replaceable by any other radio access node (e.g., base station (“BS”), eNB, gNB, access point (“AP”), new radio (“NR”), and so forth. Moreover, while various embodiments described herein may be in relation to a fifth generation (“5G”) NR system, the mailing address may be equally applicable to other mobile communication systems supporting serving cells and/or carriers configured for sidelink communication over a UE to UE (“PC5”) interface.

It should be noted that the following terminology is used in this document: 1) UE-to-network relay: N-relay; 2) UE-to-UE relay: UE-relay; and 3) Relay=either a UE-to-network relay or a UE-to-UE relay.

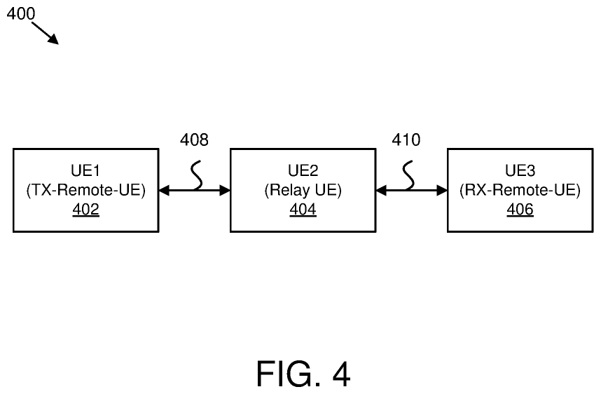

FIG. 4 is a schematic block diagram illustrating one embodiment of a system 400 for relay communications. The system 400 includes a UE1 402 (e.g., TX-Remote-UE, first UE, one or more transmit (“TX”) UEs), a UE2 404 (e.g., relay UE, second UE), and a UE3406 (e.g., RX-Remote-UE, third UE, one or more receive (“RX”) UEs). The UE1 402 communicates with the UE2 404 over a first interface 408, while the UE2 404 communicates with the UE3 406 over a second interface 410.

The UE1 402 is a UE that has some application data to be sent to another remote UE (UE3 406) via a relay (UE2 404). It should be noted that, the UE3 406 may have data to send to the UE1 402 via the UE2 404 (in this context UE3 406 would take the role of a transmitter UE). Accordingly, the terms and roles shown in FIG. 4 may be with respect to a particular data packet. In some embodiments, more than one relay is used (e.g., UE2a and UE2b), thus the UE2 404 may be a generalized representation of one or more relay UEs. In various embodiments, UE3 406 may act as a relay UE to another UE (e.g., UE4).

In a first embodiment, a UE may determine a minimum communication range (“MCR”) and/or there may be a reflective and/or non-reflective hybrid automatic repeat request (“HARQ”) configuration including the MCR. In the first embodiment, a TX remote UE maintains a unicast, groupcast, and/or broadcast connection with a relay UE in the first interface and the relay UE maintains either a unicast, groupcast, or broadcast in the second interface with the RX remote UEs.

In the first embodiment, the relay UE may use an MCR value, a cast type, and/or a present zone identifier (“ID”) (e.g., zone ID of TX remote UE) received from the first interface from the TX remote UE to seek HARQ feedback option-1 from RX remote UEs for the transmission of a TB to a certain destination ID in the second interface.

In one implementation of the first embodiment (e.g., with the same HARQ configuration for the first and the second interface, reflective), a sidelink HARQ configuration describes a usage of a sidelink HARQ feedback enable and/or disable indication, sidelink HARQ feedback options, an MCR value, a cast type, a group size, and so forth, which may be configured as reflective between the first interface and the second interface to maintain end to end quality of service (“QoS”), which may mean that the same sidelink HARQ configuration is applied for the first interface and the second interface and for the same set of destinations.

In another implementation of the first embodiment, the TX Remote UE signals an MCR value, a present zone ID of the TX Remote UE, a cast type to be used in the second interface, a group size, and/or a group member configuration semi-statically using PC5 radio resource control (“RRC”) signaling for a transmission corresponding to a logical channel ID and a certain destination layer 2 (“L2”) ID in the first interface which may be used by the relay UE in the second interface for communication with corresponding RX remote UEs.

In certain embodiments, if a TX remote UE is able to multiplex data belonging to multiple logical channels in the same TB, the TX remote UE may signal separately an MCR value, a cast type, a group size, a group member configuration of each logical channel in a packet data convergence protocol (“PDCP”) header or a MAC sub-header and the MAC sub-header may contain a present zone (e.g., zone ID of the TX remote UE). The zone ID of the TX remote UE may be periodically updated or updated based on a change in the zone ID of the TX remote UE.

In some embodiments, a TX remote UE signals dynamically in a sidelink control information (“SCI”) format 2-B or any new 2nd SCI format—an MCR value, its present zone ID (e.g., zone ID of TX remote UE), and cast type used in the first interface which may be set to unicast and another cast type field in the SCI describing the cast type used in the second interface which may be set to groupcast. For the first interface, the MCR value may be set to infinity for unicast in the SCI format 2-B or any new 2nd SCI format.

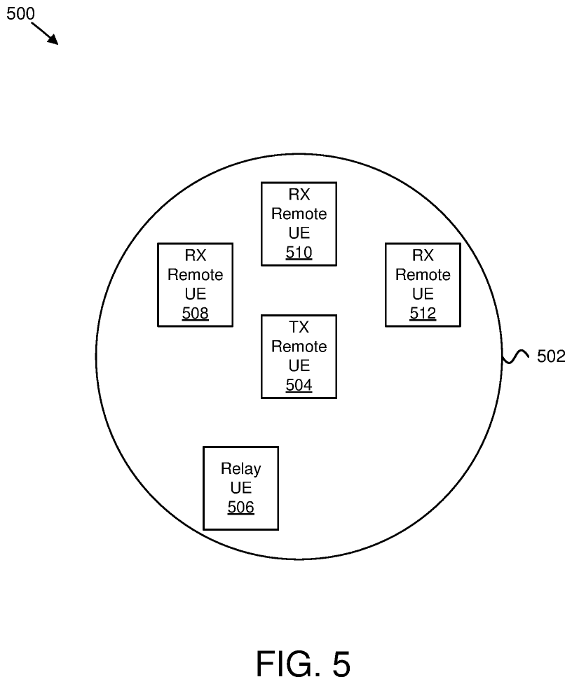

In various embodiments, a relay UE may signal an MCR value received from a TX remote UE and zone ID of the TX remote UE in the first interface to the RX remote UEs belonging to a certain destination ID and logical channel (“LCH”) in the second interface as shown in the FIG. 5. In one example, if the MCR value signaled in the first interface is set to infinity then the MCR value in the second interface is also set to infinity (e.g., non-distance based sidelink HARQ feedback is sought).

In another example, if an MCR value signaled in the first interface is set to 300 meters, then the relay UE may signal the same MCR value of 300 meters in the second interface to seek distance based sidelink HARQ feedback.

FIG. 5 is a schematic block diagram illustrating one embodiment of a system 500 in which MCR is perceived from a TX remote UE. A limit of MCR 502 is illustrated by a circle. The system 500 includes a TX remote UE 504, a relay UE 506, and RX remote UEs 508, 510, and 512. As illustrated, from the TX remote UE's 504 perspective, all other devices are within the MCR 502.

In certain embodiments, a relay UE may determine to transmit a TB based on an MCR and zone id. In such embodiments, the relay UE, after receiving the MCR value and present zone ID of a TX remote UE for each of the destination ID and logical channel from the first interface, may determine to transmit a TB in the second interface to RX remote UEs based on the comparison of the present zone ID of the relay UE to that of the MCR value and that of the zone ID of the TX remote UE for that TB. In one example, transmission of a TB in the second interface by the relay UE is made using geo-graphical information, such as zone id signaled in the first interface by the first sidelink device.

In some embodiments, if a relay UE's present zone ID is not within a signaled MCR value and with respect to a zone ID of the TX remote UE, then the Relay UE may perform according to one of the following: 1) the relay UE may disable sidelink HARQ feedback in the second interface even if a LCH of the relay UE is configured to seek sidelink HARQ feedback; 2) the relay UE may seek sidelink HARQ feedback in the second interface according to the LCH of the relay UE if configured to seek sidelink HARQ feedback; and 3) the relay UE does not transmit the TB in the second interface. The relay UE may signal feedback to the TX remote UE in the first interface for not transmitting a TB in the second interface. In one example, the relay UE may signal to the TX remote UE that it is not inside the communication range specified by the TX remote UE in the first interface through a feedback via higher layer signaling using PC5 RRC or a MAC control element (“CE”). The feedback may be transmitted as soon as the relay UE decodes the MCR value and zone ID from the TX remote UE in the first interface.

In various embodiments, there may be a TX remote UE relay selection based on a MCR. In certain embodiments, a TX remote UE may be configured with a set of values of MCR or a MCR threshold as part of relay selection and the TX remote UE may enable a use_relay field in SCI only if the MCR provided to the TX remote UE by its higher layer matches that of the configured set of values or is above the configured MCR threshold.

Certain embodiments may be considered non-reflective in which a relay UE decides a sidelink HARQ for the second interface. In such embodiments, the relay UE may determine to seek sidelink HARQ feedback independently based on its own LCH configuration and the relay UE may ignore the sidelink HARQ feedback configuration provided by the TX remote UE in the first interface to set the sidelink HARQ configuration in the second interface.

In one example, the relay UE may set a sidelink HARQ feedback enable and/or disable indicator, and a sidelink HARQ feedback option-1 or sidelink HARQ feedback option-2 (e.g., distance based or non-distance based) based on an availability of a physical sidelink feedback channel (“PSFCH”) resource and a group size at the relay UE.

Some embodiments may be considered non-reflective in which a zone ID of a relay UE is signaled in the second interface. In such embodiments, the relay UE may signal in the second interface, a present zone ID of the relay UE and a corresponding MCR value received from the TX remote UE in the first interface to the RX remote UEs belonging to a certain destination ID and LCH. In one example, the relay UE may determine to signal its present zone ID if there is no zone ID signaled in the first interface from the TX remote UE. In another example, the relay UE may ignore the zone ID of the TX remote UE signaled in the first interface and may independently choose to signal the zone ID of the relay UE in the second interface.

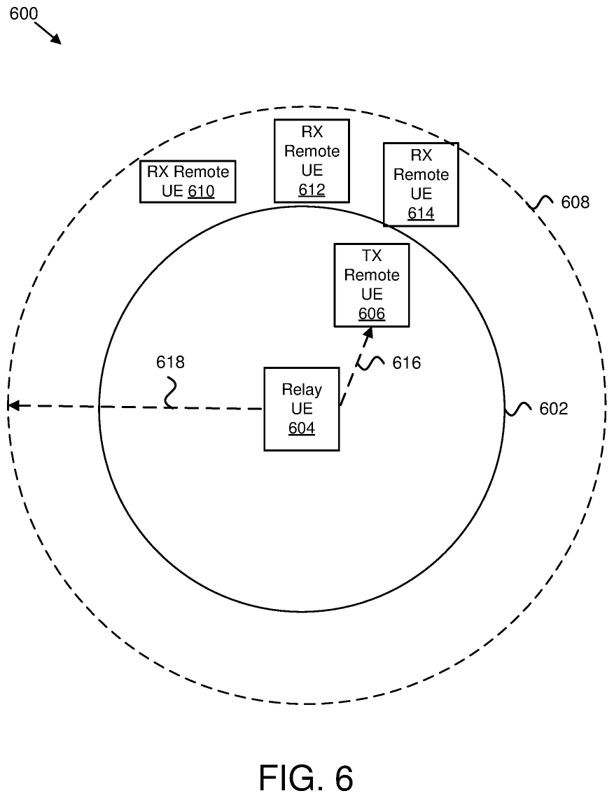

Various embodiments may use a zone ID of a TX remote UE and a modified MCR value signaled in the second interface. In such embodiments, a relay UE may signal in the second interface a present zone ID of the TX remote UE and may determine the MCR value to be signaled in the second interface according to one of the following: 1) the relay UE adjusts the signaled MCR from the TX remote UE with ‘x’ meters based on a location of the RX remote UEs from that of the TX remote UE and the relay UE which is done to have a similar interpretation of a number of UEs within the MCR as perceived by the TX remote UE and the relay UE—in one example, subtracting or adding ‘x’ meters to the original MCR value signaled from the TX remote UE based on the sidelink pathloss calculated between the TX remote UE and the relay UE as shown in the FIG. 6; and 2) if the relay UE receives data from more than one TX Remote UE and also the data originating from the relay UE to the RX remote UEs towards the same destination ID in the second interface, then the relay UE may form a TB multiplexed with data from more than one TX remote UE to the same destination ID and may select the highest MCR for transmitting this TB to the remote UEs in the second interface.

In certain embodiments, a relay UE may signal in the second interface a zone ID of the TX remote UE and may determine itself an MCR value to be signaled in the second interface based on one of the embodiments described herein.

FIG. 6 is a schematic block diagram illustrating one embodiment of a system 600 in which MCR is perceived from a relay UE. An initial limit of MCR 602 is illustrated by a circle. The system 600 includes a relay UE 604 and a TX remote UE 606 within the MCR. Furthermore, a modified MCR 608 shows the RX remote UEs 610, 612, and 614 within the modified MCR 608. A pathloss 616 between the relay UE 604 and the TX remote UE 606 is illustrated, and a TX power 618 of the relay UE 604.

Some embodiments may use a zone ID from multiple TX remote UEs transmitted to a relay UE. In such embodiments, if the relay UE receives zone ID from multiple TX remote UEs in the first interface, then the usage of zone ID in the second interface and/or multiplexing of data from LCH belonging to multiple TX remote UEs to the same destination depends on one of the following: 1) if the relay UE receives the same zone ID from multiple TX remote UEs in the first interface, then the relay UE may use the same zone ID as it received in the first interface to seek HARQ feedback in the second interface and/or may multiplex data from LCHs belonging to multiple TX remote UEs to the same destination in the second interface; 2) if the relay UE receives different zone IDs from multiple TX remote UEs in the first interface, then the relay UE does not signal the zone ID and/or highest MCR in the second interface to seek HARQ feedback and does not multiplex data from LCHs belonging to multiple TX Remote UEs to the same destination in the second interface; 3) if the relay UE receives different zone IDs from multiple TX remote UEs in the first interface, then the relay UE may decide independently to use the zone ID of the relay UE and/or the highest MCR in the second interface to seek HARQ feedback and/or may multiplex data from LCHs belonging to multiple TX remote UEs for the same destination in the second interface; 4) if the relay UE receives different zone IDs from multiple TX remote UEs in the first interface, then the relay UE may disable HARQ feedback in the second interface; and 5) if the relay UE receives different zone IDs from multiple TX remote UEs in the first interface, then the relay UE may take an average zone value, a middle zone value, and/or a zone ID belonging to a TX remote UE that has a larger distance from the relay UE and/or zone ID belonging to the larger zone configuration if there is more than one configured zone configuration.

In various embodiments, a zone ID of the RX remote UE may be signaled back to the TX remote UE using higher layer signaling such as MAC CE or using SCI (e.g., may be periodically transmitted or requested from peer UEs). In certain embodiments, the TX remote UE may calculate a distance between itself and RX remote UEs using signaled zone values and may decide to enable sidelink HARQ in the second interface if it is above a configured value.

A second embodiment may correspond to TX power control. In the second embodiment, the relay UE may signal in the second interface a present zone ID of the TX remote UE and an MCR value signaled in the first interface. The number of UEs interpreted by the relay UE as being within the MCR may be differently interpreted from that of the TX remote UE and it may depend on a distance between the TX remote UE and the relay UE.

In certain embodiments, if a distance between the TX remote UE and the relay UE is within a configured threshold of ‘x’ meters, then one interpretation of a number of UEs within a MCR may be the same as that perceived from the TX remote UE and the relay UE. In one example, ‘x’ meters may be equal to or smaller than a size of a zone configured in a gNB. In another example, if a sidelink pathloss estimated between the TX remote UE and the relay UE is within a configured threshold, then there may be no additional behavior for the relay UE, where the configuration of the threshold is such that it is smaller than the size of a zone configured in a corresponding gNB.

In some embodiments, a transmit power of the relay UE in the second interface for transmission towards RX remote UEs may be increased and may be based on a sidelink pathloss measured in the first interface between the TX remote UE and the relay UE.

Various embodiments may be reflective and/or non-reflective and may use P0 and alpha for an interface. In such embodiments, the configuration of the P0 and alpha values may be similarly configured between the first interface and the second interface and the transmit power of the relay UE to be used in the second interface may depend on a sidelink pathloss between the TX remote UE and the relay UE. In one example, the P0 and alpha values may be exchanged using PC5 RRC signaling. In certain embodiments, the P0 and the alpha values may be independently configured in the first interface and the second interface.

In a third embodiment, a UE to UE relay may be used where each interface uses a different radio access technology (“RAT”). In the third embodiment, a first RAT may be configured to be used in the first interface by the relay UE and the second RAT may be configured to be used in the second interface. The relay UE may support both RAT configurations enabling communication between the TX remote UE and the RX remote UE and a mapping between the QoS of one RAT and another RAT may be signaled to the relay UE by a gNB, may be configured, or may be preconfigured.

In certain embodiments, the relay UE may decide on a sidelink HARQ configuration for the second interface independently based on its own LCH configuration and provided QoS mapping information.

In some embodiments, a first RAT and a second RAT in various embodiments described herein may be frequency range 1 (“FR1”) (e.g., below 6 GHz) and frequency range 2 (“FR2”) and/or frequency range 4 (“FR4”) (e.g., above 6 GHz and/or above 52.6 GHz).

In a fourth embodiment, in mode 2 autonomous resource allocation, the TX remote UE may signal information involving parameters like PC5 5G QoS identifier (“PQI”), periodicity of a packet arrival, a latency, a packet delay budget (“PDB”), a packet size, a buffer status report along with a respective source ID and destination ID, a candidate resource selection window containing starting and ending sidelink slots or ratio of PDB to be used for selection of resources in each of the interfaces otherwise PDB used in each interface to the relay UE in the second interface using a PC5 RRC connection, the relay UE may trigger a resource selection and/or a reselection mechanism as soon as it receives assistance information from the TX remote UE in the first interface and the candidate resource selection may be performed taking into account the remaining PDB (e.g., after the PDB used in the first interface by the TX remote UE and/or candidate resource selection widow) and the relay UE may pre-select and/or reserve a resource within the candidate resource selection widow to be used in the second interface, where the candidate resource window to be used in the second interface takes into consideration the PDB to be used in the first interface and to be used in the second interface.

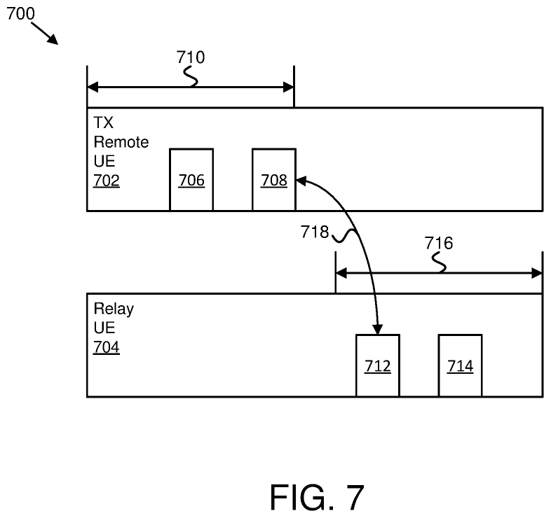

FIG. 7 is a schematic block diagram illustrating one embodiment of a system 700 including a selection window of a TX remote UE 702 and a relay UE 704. For the TX remote UE 702, a first candidate 706 and a second candidate 708 are within a candidate resource selection window 710, and for the relay UE 704, a first candidate 712 and a second candidate 714 are within a candidate resource selection window 716. The second candidate 708 of the TX remote UE 702 corresponds to the first candidate 712 of the relay UE 704.

In a fifth embodiment, a sidelink discontinuous reception (“DRX”) cycle configuration to be used in the first interface may be exchanged and/or negotiated between the TX remote UE and relay UE and, in one option, the sidelink DRX cycle may be negotiated in the first interface by the relay UE based on the sidelink DRX cycle configuration used in the second interface or based on the DRX cycle configuration of other TX remote UEs in the first interface. The DRX cycle configuration may include an on-duration of the relay UE, an offset, and a periodicity may be signaled with both TX remote UEs and the RX remote UEs.

In one example, the relay UE may perform reception of data from the TX remote UE in the first interface and transmission of data to the remote UEs in the second interface using the same DRX on-duration and/or active reception period or receive data in the first on-duration period and transmit data in the second on-duration period of a DRX configuration cycle. An inactivity timer of the TX remote UE may be started and/or restarted based on feedback from the first interface and second interface.

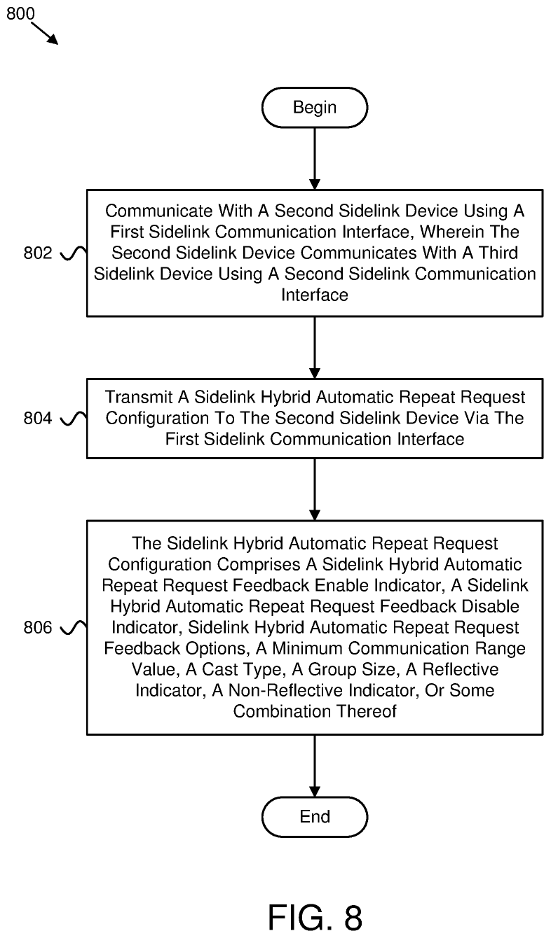

FIG. 8 is a flow chart diagram illustrating one embodiment of a method 800 for configuring a sidelink hybrid automatic repeat request. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes communicating 802, via a first sidelink device, with a second sidelink device using a first sidelink communication interface. The second sidelink device communicates with a third sidelink device using a second sidelink communication interface. In some embodiments, the method 800 includes transmitting 804 a sidelink hybrid automatic repeat request configuration to the second sidelink device via the first sidelink communication interface. In certain embodiments, the sidelink hybrid automatic repeat request configuration includes 806 a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In certain embodiments, the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface. In some embodiments, the second sidelink device transmits a transport block using the second sidelink communication interface based on a geographic zone indicated in the sidelink hybrid automatic repeat request configuration.

In various embodiments, the second sidelink device multiplexes data received from a plurality of devices over the first sidelink communication interface according to a geographic zone indicated in the sidelink hybrid automatic repeat request, and transmits the multiplexed data over the second sidelink communication interface. In one embodiment, the second sidelink device receives a same zone identifier from the plurality of devices, and transmits the multiplexed data and requests to receive hybrid automatic repeat request feedback over the second sidelink communication interface based on the same zone identifier.

In certain embodiments, the second sidelink device receives different zone identifiers from the plurality of devices, and the multiplexed data is not transmitted based on a zone identifier. In some embodiments, the second sidelink device receives different zone identifiers from the plurality of devices, and transmits the multiplexed data and requests to receive hybrid automatic repeat request feedback based on a zone identifier of the second sidelink device.

In various embodiments, the second sidelink device receives different zone identifiers from the plurality of devices, and disables hybrid automatic repeat request feedback over the second sidelink communication interface. In one embodiment, the reflective indicator indicates to the second sidelink device to provide the same sidelink hybrid automatic repeat request configuration to the third sidelink device.

In certain embodiments, the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration. In some embodiments, the sidelink hybrid automatic repeat request configuration comprises the minimum communication range value, and the second sidelink device signals the same minimum communication range value to the third sidelink device. In various embodiments, the sidelink hybrid automatic repeat request configuration comprises the minimum communication range value, and the second sidelink device signals a second minimum communication range value to the third sidelink device.

In one embodiment, the sidelink hybrid automatic repeat request configuration comprises a zone identifier, and the second sidelink device signals the zone identifier to the third sidelink device. In certain embodiments, the sidelink hybrid automatic repeat request configuration comprises a zone identifier, and the second sidelink device signals a second zone identifier corresponding to the second sidelink device to the third sidelink device. In some embodiments, the second sidelink device requests sidelink hybrid automatic repeat request feedback based on a logical channel configuration of the second sidelink device.

In various embodiments, the sidelink hybrid automatic repeat request configuration comprises a zone identifier of the first sidelink device and the minimum communication range value, and the second sidelink device determines to transmit a transport block over the second interface based on a comparison of a second zone identifier of the second sidelink device, the zone identifier of the first sidelink device, and the minimum communication range value. In one embodiment, as a result of the second zone identifier not being within the minimum communication range value with respect to the zone identifier of the first sidelink device, the second sidelink device disables sidelink hybrid automatic repeat request feedback in the second interface.

In certain embodiments, as a result of the second zone identifier not being within the minimum communication range value with respect to the zone identifier of the first sidelink device, the second sidelink device does not transmit the transport block in the second interface. In some embodiments, as a result of the second zone identifier not being within the minimum communication range value with respect to the zone identifier of the first sidelink device, the second sidelink device enables sidelink hybrid automatic repeat request feedback in the second interface.

In various embodiments, the second sidelink device determines a transmit power of the second sidelink device in the second interface based on a sidelink pathloss measured in the first interface between the first sidelink device and the second sidelink device. In one embodiment, the method 800 further comprises enabling transmission to the second sidelink device as a result of a minimum communication range threshold matching the minimum communication range value.

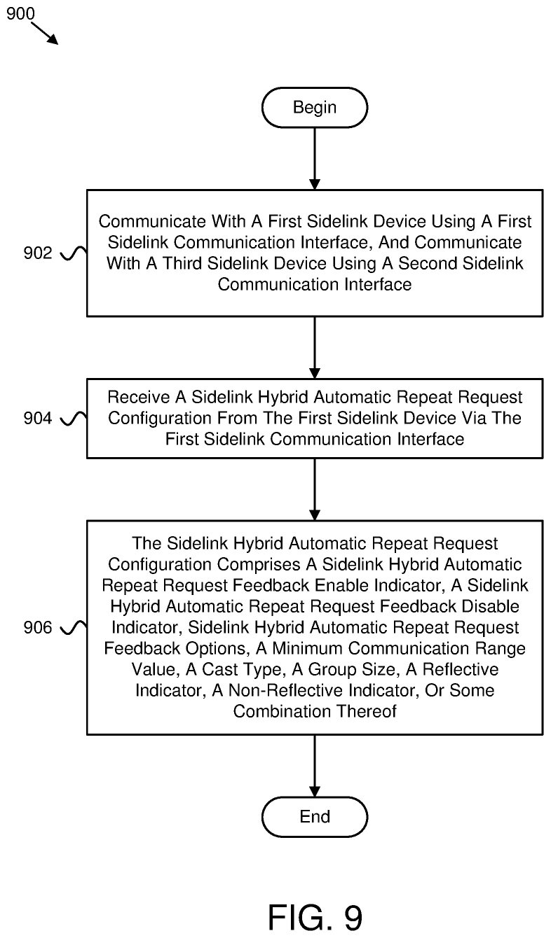

FIG. 9 is a flow chart diagram illustrating another embodiment of a method 900 for configuring a sidelink hybrid automatic repeat request. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes communicating 902, via a second sidelink device, with a first sidelink device using a first sidelink communication interface, and communicating with a third sidelink device using a second sidelink communication interface. In some embodiments, the method 900 includes receiving 904 a sidelink hybrid automatic repeat request configuration from the first sidelink device via the first sidelink communication interface. In certain embodiments, the sidelink hybrid automatic repeat request configuration includes 906 a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In certain embodiments, the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface. In some embodiments, the method 900 further comprises transmitting a transport block using the second sidelink communication interface based on a geographic zone indicated in the sidelink hybrid automatic repeat request configuration.

In various embodiments, the method 900 further comprises multiplexing data received from a plurality of devices over the first sidelink communication interface according to a geographic zone indicated in the sidelink hybrid automatic repeat request, and transmitting the multiplexed data over the second sidelink communication interface. In one embodiment, the method 900 further comprises receiving a same zone identifier from the plurality of devices, and transmitting the multiplexed data and requesting to receive hybrid automatic repeat request feedback over the second sidelink communication interface based on the same zone identifier.

In certain embodiments, the method 900 further comprises receiving different zone identifiers from the plurality of devices, and not transmitting the multiplexed data based on a zone identifier. In some embodiments, the method 900 further comprises receiving different zone identifiers from the plurality of devices, and transmitting the multiplexed data and requesting to receive hybrid automatic repeat request feedback based on a zone identifier of the second sidelink device. In various embodiments, the method 900 further comprises receiving different zone identifiers from the plurality of devices, and disabling hybrid automatic repeat request feedback over the second sidelink communication interface.

In one embodiment, the reflective indicator indicates to the second sidelink device to provide the same sidelink hybrid automatic repeat request configuration to the third sidelink device. In certain embodiments, the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration. In some embodiments, the sidelink hybrid automatic repeat request configuration comprises the minimum communication range value, and the method 900 further comprises signaling the same minimum communication range value to the third sidelink device.

In various embodiments, the sidelink hybrid automatic repeat request configuration comprises the minimum communication range value, and the method further comprises signaling a second minimum communication range value to the third sidelink device. In one embodiment, the sidelink hybrid automatic repeat request configuration comprises a zone identifier, and the method 900 further comprises signaling the zone identifier to the third sidelink device. In certain embodiments, the sidelink hybrid automatic repeat request configuration comprises a zone identifier, and the method 900 further comprises signaling a second zone identifier corresponding to the second sidelink device to the third sidelink device.

In some embodiments, the method 900 further comprises requesting sidelink hybrid automatic repeat request feedback based on a logical channel configuration of the second sidelink device. In various embodiments, the sidelink hybrid automatic repeat request configuration comprises a zone identifier of the first sidelink device and the minimum communication range value, and the method further comprises determining to transmit a transport block over the second interface based on a comparison of a second zone identifier of the second sidelink device, the zone identifier of the first sidelink device, and the minimum communication range value. In one embodiment, as a result of the second zone identifier not being within the minimum communication range value with respect to the zone identifier of the first sidelink device, the method 900 further comprises disabling sidelink hybrid automatic repeat request feedback in the second interface.

In certain embodiments, as a result of the second zone identifier not being within the minimum communication range value with respect to the zone identifier of the first sidelink device, the method 900 further comprises not transmitting the transport block in the second interface. In some embodiments, as a result of the second zone identifier not being within the minimum communication range value with respect to the zone identifier of the first sidelink device, the method 900 further comprises enabling sidelink hybrid automatic repeat request feedback in the second interface.

In various embodiments, the method further comprises determining a transmit power of the second sidelink device in the second interface based on a sidelink pathloss measured in the first interface between the first sidelink device and the second sidelink device. In one embodiment, transmission to the second sidelink device is enabled as a result of a minimum communication range threshold matching the minimum communication range value.

In one embodiment, a method of a first sidelink device comprises: communicating with a second sidelink device using a first sidelink communication interface, wherein the second sidelink device communicates with a third sidelink device using a second sidelink communication interface; and transmitting a sidelink hybrid automatic repeat request configuration to the second sidelink device via the first sidelink communication interface; wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In certain embodiments, the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface.

In some embodiments, the second sidelink device transmits a transport block using the second sidelink communication interface based on a geographic zone indicated in the sidelink hybrid automatic repeat request configuration.

In various embodiments, the second sidelink device multiplexes data received from a plurality of devices over the first sidelink communication interface according to a geographic zone indicated in the sidelink hybrid automatic repeat request, and transmits the multiplexed data over the second sidelink communication interface.

In one embodiment, the second sidelink device receives a same zone identifier from the plurality of devices, and transmits the multiplexed data and requests to receive hybrid automatic repeat request feedback over the second sidelink communication interface based on the same zone identifier.

In certain embodiments, the second sidelink device receives different zone identifiers from the plurality of devices, and the multiplexed data is not transmitted based on a zone identifier.

In some embodiments, the second sidelink device receives different zone identifiers from the plurality of devices, and transmits the multiplexed data and requests to receive hybrid automatic repeat request feedback based on a zone identifier of the second sidelink device.

In various embodiments, the second sidelink device receives different zone identifiers from the plurality of devices, and disables hybrid automatic repeat request feedback over the second sidelink communication interface.

In one embodiment, the reflective indicator indicates to the second sidelink device to provide the same sidelink hybrid automatic repeat request configuration to the third sidelink device.

In certain embodiments, the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration.

In some embodiments, the sidelink hybrid automatic repeat request configuration comprises the minimum communication range value, and the second sidelink device signals the same minimum communication range value to the third sidelink device.

In various embodiments, the sidelink hybrid automatic repeat request configuration comprises the minimum communication range value, and the second sidelink device signals a second minimum communication range value to the third sidelink device.

In one embodiment, the sidelink hybrid automatic repeat request configuration comprises a zone identifier, and the second sidelink device signals the zone identifier to the third sidelink device.

In certain embodiments, the sidelink hybrid automatic repeat request configuration comprises a zone identifier, and the second sidelink device signals a second zone identifier corresponding to the second sidelink device to the third sidelink device.

In some embodiments, the second sidelink device requests sidelink hybrid automatic repeat request feedback based on a logical channel configuration of the second sidelink device.

In various embodiments, the sidelink hybrid automatic repeat request configuration comprises a zone identifier of the first sidelink device and the minimum communication range value, and the second sidelink device determines to transmit a transport block over the second interface based on a comparison of a second zone identifier of the second sidelink device, the zone identifier of the first sidelink device, and the minimum communication range value.

In one embodiment, as a result of the second zone identifier not being within the minimum communication range value with respect to the zone identifier of the first sidelink device, the second sidelink device disables sidelink hybrid automatic repeat request feedback in the second interface.

In certain embodiments, as a result of the second zone identifier not being within the minimum communication range value with respect to the zone identifier of the first sidelink device, the second sidelink device does not transmit the transport block in the second interface.

In some embodiments, as a result of the second zone identifier not being within the minimum communication range value with respect to the zone identifier of the first sidelink device, the second sidelink device enables sidelink hybrid automatic repeat request feedback in the second interface.

In various embodiments, the second sidelink device determines a transmit power of the second sidelink device in the second interface based on a sidelink pathloss measured in the first interface between the first sidelink device and the second sidelink device.

In one embodiment, the method further comprises enabling transmission to the second sidelink device as a result of a minimum communication range threshold matching the minimum communication range value.

In one embodiment, an apparatus comprises a first sidelink device. The apparatus further comprises: a transceiver that: communicates with a second sidelink device using a first sidelink communication interface, wherein the second sidelink device communicates with a third sidelink device using a second sidelink communication interface; and transmits a sidelink hybrid automatic repeat request configuration to the second sidelink device via the first sidelink communication interface; wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In certain embodiments, the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface.

In some embodiments, the second sidelink device transmits a transport block using the second sidelink communication interface based on a geographic zone indicated in the sidelink hybrid automatic repeat request configuration.

In various embodiments, the second sidelink device multiplexes data received from a plurality of devices over the first sidelink communication interface according to a geographic zone indicated in the sidelink hybrid automatic repeat request, and transmits the multiplexed data over the second sidelink communication interface.

In one embodiment, the second sidelink device receives a same zone identifier from the plurality of devices, and transmits the multiplexed data and requests to receive hybrid automatic repeat request feedback over the second sidelink communication interface based on the same zone identifier.

In certain embodiments, the second sidelink device receives different zone identifiers from the plurality of devices, and the multiplexed data is not transmitted based on a zone identifier.

In some embodiments, the second sidelink device receives different zone identifiers from the plurality of devices, and transmits the multiplexed data and requests to receive hybrid automatic repeat request feedback based on a zone identifier of the second sidelink device.

In various embodiments, the second sidelink device receives different zone identifiers from the plurality of devices, and disables hybrid automatic repeat request feedback over the second sidelink communication interface.

In one embodiment, the reflective indicator indicates to the second sidelink device to provide the same sidelink hybrid automatic repeat request configuration to the third sidelink device.

In certain embodiments, the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration.

In some embodiments, the sidelink hybrid automatic repeat request configuration comprises the minimum communication range value, and the second sidelink device signals the same minimum communication range value to the third sidelink device.

In various embodiments, the sidelink hybrid automatic repeat request configuration comprises the minimum communication range value, and the second sidelink device signals a second minimum communication range value to the third sidelink device.

In one embodiment, the sidelink hybrid automatic repeat request configuration comprises a zone identifier, and the second sidelink device signals the zone identifier to the third sidelink device.

In certain embodiments, the sidelink hybrid automatic repeat request configuration comprises a zone identifier, and the second sidelink device signals a second zone identifier corresponding to the second sidelink device to the third sidelink device.

In some embodiments, the second sidelink device requests sidelink hybrid automatic repeat request feedback based on a logical channel configuration of the second sidelink device.

In various embodiments, the sidelink hybrid automatic repeat request configuration comprises a zone identifier of the first sidelink device and the minimum communication range value, and the second sidelink device determines to transmit a transport block over the second interface based on a comparison of a second zone identifier of the second sidelink device, the zone identifier of the first sidelink device, and the minimum communication range value.

In one embodiment, as a result of the second zone identifier not being within the minimum communication range value with respect to the zone identifier of the first sidelink device, the second sidelink device disables sidelink hybrid automatic repeat request feedback in the second interface.

In certain embodiments, as a result of the second zone identifier not being within the minimum communication range value with respect to the zone identifier of the first sidelink device, the second sidelink device does not transmit the transport block in the second interface.

In some embodiments, as a result of the second zone identifier not being within the minimum communication range value with respect to the zone identifier of the first sidelink device, the second sidelink device enables sidelink hybrid automatic repeat request feedback in the second interface.

In various embodiments, the second sidelink device determines a transmit power of the second sidelink device in the second interface based on a sidelink pathloss measured in the first interface between the first sidelink device and the second sidelink device.

In one embodiment, the apparatus further comprises a processor that enables transmission to the second sidelink device as a result of a minimum communication range threshold matching the minimum communication range value.

In one embodiment, a method of a second sidelink device comprises: communicating with a first sidelink device using a first sidelink communication interface, and communicating with a third sidelink device using a second sidelink communication interface; and receiving a sidelink hybrid automatic repeat request configuration from the first sidelink device via the first sidelink communication interface; wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In certain embodiments, the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface.

In some embodiments, the method further comprises transmitting a transport block using the second sidelink communication interface based on a geographic zone indicated in the sidelink hybrid automatic repeat request configuration.

In various embodiments, the method further comprises multiplexing data received from a plurality of devices over the first sidelink communication interface according to a geographic zone indicated in the sidelink hybrid automatic repeat request, and transmitting the multiplexed data over the second sidelink communication interface.

In one embodiment, the method further comprises receiving a same zone identifier from the plurality of devices, and transmitting the multiplexed data and requesting to receive hybrid automatic repeat request feedback over the second sidelink communication interface based on the same zone identifier.

In certain embodiments, the method further comprises receiving different zone identifiers from the plurality of devices, and not transmitting the multiplexed data based on a zone identifier.

In some embodiments, the method further comprises receiving different zone identifiers from the plurality of devices, and transmitting the multiplexed data and requesting to receive hybrid automatic repeat request feedback based on a zone identifier of the second sidelink device.

In various embodiments, the method further comprises receiving different zone identifiers from the plurality of devices, and disabling hybrid automatic repeat request feedback over the second sidelink communication interface.

In one embodiment, the reflective indicator indicates to the second sidelink device to provide the same sidelink hybrid automatic repeat request configuration to the third sidelink device.

In certain embodiments, the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration.

In some embodiments, the sidelink hybrid automatic repeat request configuration comprises the minimum communication range value, and the method further comprises signaling the same minimum communication range value to the third sidelink device.

In various embodiments, the sidelink hybrid automatic repeat request configuration comprises the minimum communication range value, and the method further comprises signaling a second minimum communication range value to the third sidelink device.

In one embodiment, the sidelink hybrid automatic repeat request configuration comprises a zone identifier, and the method further comprises signaling the zone identifier to the third sidelink device.

In certain embodiments, the sidelink hybrid automatic repeat request configuration comprises a zone identifier, and the method further comprises signaling a second zone identifier corresponding to the second sidelink device to the third sidelink device.

In some embodiments, the method further comprises requesting sidelink hybrid automatic repeat request feedback based on a logical channel configuration of the second sidelink device.

In various embodiments, the sidelink hybrid automatic repeat request configuration comprises a zone identifier of the first sidelink device and the minimum communication range value, and the method further comprises determining to transmit a transport block over the second interface based on a comparison of a second zone identifier of the second sidelink device, the zone identifier of the first sidelink device, and the minimum communication range value.

In one embodiment, as a result of the second zone identifier not being within the minimum communication range value with respect to the zone identifier of the first sidelink device, the method further comprises disabling sidelink hybrid automatic repeat request feedback in the second interface.

In certain embodiments, as a result of the second zone identifier not being within the minimum communication range value with respect to the zone identifier of the first sidelink device, the method further comprises not transmitting the transport block in the second interface.

In some embodiments, as a result of the second zone identifier not being within the minimum communication range value with respect to the zone identifier of the first sidelink device, the method further comprises enabling sidelink hybrid automatic repeat request feedback in the second interface.

In various embodiments, the method further comprises determining a transmit power of the second sidelink device in the second interface based on a sidelink pathloss measured in the first interface between the first sidelink device and the second sidelink device.

In one embodiment, transmission to the second sidelink device is enabled as a result of a minimum communication range threshold matching the minimum communication range value.

In one embodiment, an apparatus comprises a second sidelink device. The apparatus further comprises: a transceiver that: communicates with a first sidelink device using a first sidelink communication interface, and communicates with a third sidelink device using a second sidelink communication interface; and receives a sidelink hybrid automatic repeat request configuration from the first sidelink device via the first sidelink communication interface; wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

In certain embodiments, the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface.

In some embodiments, the transceiver transmits a transport block using the second sidelink communication interface based on a geographic zone indicated in the sidelink hybrid automatic repeat request configuration.

In various embodiments, the apparatus further comprises a processor that multiplexes data received from a plurality of devices over the first sidelink communication interface according to a geographic zone indicated in the sidelink hybrid automatic repeat request, and wherein the transceiver transmits the multiplexed data over the second sidelink communication interface.

In one embodiment, the transceiver receives a same zone identifier from the plurality of devices, and the transceiver transmits the multiplexed data and requesting to receive hybrid automatic repeat request feedback over the second sidelink communication interface based on the same zone identifier.

In certain embodiments, the transceiver receives different zone identifiers from the plurality of devices, and the transceiver does not transmit the multiplexed data based on a zone identifier.

In some embodiments, the transceiver receives different zone identifiers from the plurality of devices, and the transceiver transmits the multiplexed data and requesting to receive hybrid automatic repeat request feedback based on a zone identifier of the second sidelink device.

In various embodiments, the apparatus further comprises a processor, wherein the transceiver receives different zone identifiers from the plurality of devices, and the processor disables hybrid automatic repeat request feedback over the second sidelink communication interface.

In one embodiment, the reflective indicator indicates to the second sidelink device to provide the same sidelink hybrid automatic repeat request configuration to the third sidelink device.

In certain embodiments, the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration.

In some embodiments, the sidelink hybrid automatic repeat request configuration comprises the minimum communication range value, and the method further comprises signaling the same minimum communication range value to the third sidelink device.

In various embodiments, the sidelink hybrid automatic repeat request configuration comprises the minimum communication range value, and the method further comprises signaling a second minimum communication range value to the third sidelink device.

In one embodiment, the sidelink hybrid automatic repeat request configuration comprises a zone identifier, and the method further comprises signaling the zone identifier to the third sidelink device.

In certain embodiments, the sidelink hybrid automatic repeat request configuration comprises a zone identifier, and the method further comprises signaling a second zone identifier corresponding to the second sidelink device to the third sidelink device.

In some embodiments, the method further comprises a processor that requests sidelink hybrid automatic repeat request feedback based on a logical channel configuration of the second sidelink device.

In various embodiments, the apparatus further comprises a processor, wherein the sidelink hybrid automatic repeat request configuration comprises a zone identifier of the first sidelink device and the minimum communication range value, and the processor determines to transmit a transport block over the second interface based on a comparison of a second zone identifier of the second sidelink device, the zone identifier of the first sidelink device, and the minimum communication range value.

In one embodiment, as a result of the second zone identifier not being within the minimum communication range value with respect to the zone identifier of the first sidelink device, the processor disables sidelink hybrid automatic repeat request feedback in the second interface.

In certain embodiments, as a result of the second zone identifier not being within the minimum communication range value with respect to the zone identifier of the first sidelink device, the transceiver does not transmit the transport block in the second interface.

In some embodiments, as a result of the second zone identifier not being within the minimum communication range value with respect to the zone identifier of the first sidelink device, the processor enables sidelink hybrid automatic repeat request feedback in the second interface.

In various embodiments, the apparatus further comprises a processor that determines a transmit power of the second sidelink device in the second interface based on a sidelink pathloss measured in the first interface between the first sidelink device and the second sidelink device.

In one embodiment, transmission to the second sidelink device is enabled as a result of a minimum communication range threshold matching the minimum communication range value.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a first sidelink device, the method comprising:
communicating with a second sidelink device using a first sidelink communication interface, wherein the second sidelink device communicates with a third sidelink device using a second sidelink communication interface; and
transmitting a sidelink hybrid automatic repeat request configuration to the second sidelink device via the first sidelink communication interface;
wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

2. An apparatus comprising a first sidelink device, the apparatus further comprising:
a transceiver that:
communicates with a second sidelink device using a first sidelink communication interface, wherein the second sidelink device communicates with a third sidelink device using a second sidelink communication interface; and
transmits a sidelink hybrid automatic repeat request configuration to the second sidelink device via the first sidelink communication interface;
wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

3. The apparatus of claim 2, wherein the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface.

4. The apparatus of claim 2, wherein the second sidelink device transmits a transport block using the second sidelink communication interface based on a geographic zone indicated in the sidelink hybrid automatic repeat request configuration.

5. The apparatus of claim 2, wherein the second sidelink device multiplexes data received from a plurality of devices over the first sidelink communication interface according to a geographic zone indicated in the sidelink hybrid automatic repeat request, and transmits the multiplexed data over the second sidelink communication interface.

6. The apparatus of claim 5, wherein the second sidelink device receives a same zone identifier from the plurality of devices, and transmits the multiplexed data and requests to receive hybrid automatic repeat request feedback over the second sidelink communication interface based on the same zone identifier.

7. The apparatus of claim 5, wherein the second sidelink device receives different zone identifiers from the plurality of devices, and the multiplexed data is not transmitted based on a zone identifier.

8. The apparatus of claim 5, wherein the second sidelink device receives different zone identifiers from the plurality of devices, and transmits the multiplexed data and requests to receive hybrid automatic repeat request feedback based on a zone identifier of the second sidelink device.

9. The apparatus of claim 5, wherein the second sidelink device receives different zone identifiers from the plurality of devices, and disables hybrid automatic repeat request feedback over the second sidelink communication interface.

10. The apparatus of claim 2, wherein the reflective indicator indicates to the second sidelink device to provide the same sidelink hybrid automatic repeat request configuration to the third sidelink device.

11. The apparatus of claim 2, wherein the non-reflective indicator indicates to the second sidelink device to provide a second sidelink hybrid automatic repeat request configuration to the third sidelink device, and the sidelink hybrid automatic repeat request configuration is different from the second sidelink hybrid automatic repeat request configuration.

12. The apparatus of claim 2, wherein the sidelink hybrid automatic repeat request configuration comprises the minimum communication range value, and the second sidelink device signals the same minimum communication range value to the third sidelink device.

13. The apparatus of claim 2, wherein the sidelink hybrid automatic repeat request configuration comprises the minimum communication range value, and the second sidelink device signals a second minimum communication range value to the third sidelink device.

14. The apparatus of claim 2, wherein the sidelink hybrid automatic repeat request configuration comprises a zone identifier, and the second sidelink device signals the zone identifier to the third sidelink device.

15. An apparatus comprising a second sidelink device, the apparatus further comprising:
a transceiver that:
communicates with a first sidelink device using a first sidelink communication interface, and communicates with a third sidelink device using a second sidelink communication interface; and
receives a sidelink hybrid automatic repeat request configuration from the first sidelink device via the first sidelink communication interface;
wherein the sidelink hybrid automatic repeat request configuration comprises a sidelink hybrid automatic repeat request feedback enable indicator, a sidelink hybrid automatic repeat request feedback disable indicator, sidelink hybrid automatic repeat request feedback options, a minimum communication range value, a cast type, a group size, a reflective indicator, a non-reflective indicator, or some combination thereof.

16. The apparatus of claim 15, wherein the sidelink hybrid automatic repeat request configuration comprises the cast type and the minimum communication range value to be used by the second sidelink device, and the cast type and the minimum communication range value are signaled to the second sidelink device semi-statically using radio resource configuration signaling transmitted over the first sidelink communication interface or using sidelink configuration information transmitted over the first sidelink communication interface.

17. The apparatus of claim 15, wherein the transceiver transmits a transport block using the second sidelink communication interface based on a geographic zone indicated in the sidelink hybrid automatic repeat request configuration.

18. The apparatus of claim 15, further comprising a processor that multiplexes data received from a plurality of devices over the first sidelink communication interface according to a geographic zone indicated in the sidelink hybrid automatic repeat request, and wherein the transceiver transmits the multiplexed data over the second sidelink communication interface.

19. The apparatus of claim 18, wherein the transceiver receives a same zone identifier from the plurality of devices, and the transceiver transmits the multiplexed data and requesting to receive hybrid automatic repeat request feedback over the second sidelink communication interface based on the same zone identifier.

20. The apparatus of claim 18, wherein the transceiver receives different zone identifiers from the plurality of devices, and the transceiver does not transmit the multiplexed data based on a zone identifier.
